(19) United States
(12) Patent Application Publication
(10) Pub. No.: US 2025/0322466 A1
(43) Pub. Date: Oct. 16, 2025

(54) EARNINGS INSIGHTS SYSTEM AND METHODS FOR EMPOWERING AGENTS WITH VISIBILITY INTO EXTRA HOURS IMPACT

(71) Applicant: NICE LTD., Ra'anana (IL)

(72) Inventors: Shilpa SHEGAONKAR, Pune (IN); Laukik PATIL, Bhiwandi (IN); Gaurav SURYAWANSHI, Pune (IN)

(21) Appl. No.: 18/635,374

(22) Filed: Apr. 15, 2024

(51) Int. Cl. G06Q 40/12; G06Q 10/1057

(52) U.S. Cl. CPC G06Q 40/125; G06Q 10/1057

(57) ABSTRACT

Earnings visibility systems and methods, and non-transitory computer readable media, include receiving a request for extra time or time off, wherein the extra time or time off corresponds to a first time interval; displaying the first time interval via a graphical user interface (GUI); receiving a net staffing value for the first time interval; receiving a payroll rule that specifies a percentage increase or decrease in pay based on the net staffing value for the first time interval; assigning a color to a particular percentage increase or decrease in pay for the first time interval; determining the percentage increase or decrease in pay for the first time interval based on the net staffing value for the first time interval; and coloring the first time interval on the GUI with the assigned color based on the percentage increase or decrease in pay for the first time interval.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems for increasing earnings visibility, and more particularly to methods and systems that use colors on a graphical user interface to color code earning opportunities.

### BACKGROUND

In many contact centers, there is a common problem where agents lack visibility into how much they can earn by working specific shifts or putting in extra hours, or how much they will lose if they do not opt for a particular shift. This lack of visibility can create several challenges for agents such as incentive misalignment, reduced motivation, and lack of personalized planning.

When agents are unaware of the financial impact of their schedule choices, they may not clearly understand the potential earnings they can achieve. This can lead to a misalignment between their personal goals and the contact center's goals, resulting in suboptimal scheduling decisions.

Without knowledge of the financial benefits tied to their schedule choices, agents may lack the motivation to take on additional shifts or work extra hours. Similarly, they may not feel motivated to avoid time off during a busy period if they are unaware of the potential loss in earnings associated with those absences.

Agents may have personal financial goals or commitments that require them to earn a certain amount of income. Without knowing the potential earnings associated with different shifts and hours, they cannot effectively plan their schedules to meet their financial needs.

In addition, in many contact centers, there is a problem where managers lack visibility into how they can minimize costs by optimizing agent shifts, allowing them to work extra hours, or strategically granting time off during overstaffed situations. This lack of awareness creates several challenges such as inefficient resource allocation, cost inefficiencies, and limited operational agility.

Contact centers rely on effective workforce management to optimize staffing levels and meet customer demand. Without visibility into the financial implications of schedule choices, it becomes challenging to allocate resources efficiently. This can result in underutilization of the available workforce or inadequate coverage during high-demand periods.

Without a clear understanding of the financial impact of different scheduling decisions, managers may struggle to minimize costs effectively. They may inadvertently allocate excessive resources, resulting in higher labor expenses than necessary.

Without insights into cost saving opportunities, managers may lack the flexibility to respond quickly to changing business needs. For example, during overstaffed situations, they may not be able to identify surplus agents and efficiently offer agents time to reduce costs.

Accordingly, there is a need for providing agents with a clear view of how their earnings are influenced by their schedule choices and empowering agents at contact centers to make more informed decisions.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of an earnings visibility system according to embodiments of the present disclosure.

FIG. 2 is an exemplary payroll rule creation page according to embodiments of the present disclosure.

FIG. 3 illustrates a user interface for an agent according to embodiments of the present disclosure.

FIG. 4 shows an exemplary method for requesting extra hours according to embodiments of the present disclosure.

FIG. 5 shows a method for generating a payroll report according to embodiments of the present disclosure.

FIG. 6 shows an exemplary algorithm according to embodiments of the present disclosure.

FIG. 7 is a flowchart of a method according to embodiments of the present disclosure.

FIG. 8 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting-the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present systems and methods increase visibility of earnings potential for agents. This visibility enables agents to align their preferences with financial incentives, leading to improved motivation, better workforce planning, and enhanced overall performance.

Typically, an agent in a workforce management (WFM) system can see the extra hours or time off opportunities depending on net staffing conditions. The agents, however, have no idea how much they will earn or lose when they apply for a particular time slot or interval, or request time off, as this can depend on various factors including extra pay for certain hours such as holidays or weekends, overtime pay, incentive pay, availability of a makeup shift or loss of a shift, etc.

Imagine there is a contact center where the net staffing is very low between 4-5 pm. More agents are needed than the agents that are scheduled. There is an immediate business need to support the customer that cannot be delayed. Under such circumstances, the manager is ready to pay more wages to the agents who show up. These earnings insights/wages should be visible to agents to make an informed decision.

Similarly, when agents are taking time off, the present systems and methods can provide them insights into how much money they are going to lose if they opt out of this shift or how much they might make if they choose and are approved for a particular extra or alternate shift. More detailed insights can be provided about other shifts where the loss can be reduced for the contact center.

The present disclosure describes systems and methods that provide a clear visibility to the agents about their earnings even before they opt out or in for a particular time interval so that they can make more informed decisions. The present disclosure provides managers with the necessary visibility so that contact centers can achieve significant cost savings. With the ability to identify cost-saving opportunities, managers can more strategically schedule agents, allow extra hours when needed, and grant time off during overstaffed conditions. This optimized resource allocation improves cost efficiency, enhances operational agility, and facilitates more accurate budgeting and forecasting.

In various embodiments, the present systems and methods implement an earnings estimator tool within the WFM system. The earnings estimator tool calculates the earnings/renumeration for the agents based on their overtime shifts, the definition of payroll codes, and net staffing conditions. The present disclosure provides agents with real-time visibility into their earnings if they plan to work extra hours or take time off. Earnings are calculated in real-time so agents can see how their income increases as they put in additional hours or decreases as they take time off.

Advantageously, the earnings estimator tool can calculate agents' earnings in real-time even before they opt for overtime, thereby providing immediate feedback on their financial incentives. Agents' dashboards are also updated with the calculated earnings for that particular interval when they intend to work extra hours.

In some embodiments, the present systems are integrated with payroll systems, ensuring that overtime earnings are accurately reflected in agents' paychecks. Agents can then access their payroll statements through the WFM system to review their overtime pay.

In various embodiments, agents can generate earnings reports from the WFM system. These reports detail their regular wages and any additional earnings, such as overtime pay and bonuses. This information helps agents track their financial progress. WFM systems may maintain a history of agents' earnings, allowing them to review past overtime earnings and assess how additional hours impact their overall income. The present systems and methods provide transparency by clearly indicating how overtime rates are calculated, any thresholds for earning overtime, and the company's policies regarding extra hours. The WFM system can show flags or warnings, or even prevent, certain staffing requests or approvals based on such policies and/or applicable law (e.g., maximum hours for a working minor, certain levels of increased pay for holidays in a given jurisdiction, etc.)

Calculations can be done for agents' time off in a similar way and can be shown to agents before they apply for a shift modification (i.e., deletion, addition, or substitution). This will make them aware of the wages they are losing if they take time off for a particular time interval. If needed, they can opt for another time interval, which will incur less loss for the agent.

The present invention is innovative due to its capacity to address a significant issue currently unaddressed within existing WFM systems. The prevailing WFM system typically incorporates self-service features that allocate slots on the agent screen to indicate availability for time off or additional hours. These slots may either be automatically approved (or pre-approved for manager review) or forwarded for managerial approval based on business requirements and the net staffing level at the given moment. However, in both scenarios, agents currently lack awareness of the potential benefits or drawbacks associated with their choices. When an agent selects a specific overtime slot, they are unaware of the corresponding advantages they will receive. Consequently, many agents may abstain from opting for additional or different hours beyond their designated shifts, or they may choose suboptimal options. Simultaneously, managers may face urgent business needs without any available agents, as the workforce remains uninformed about potential incentives or merely more convenient opportunities at comparable compensation.

In response, the present invention provides a visualization of these slots by representing benefits and offerings through color on a graphical user interface. In an exemplary embodiment, a color gradient is used. These gradients correlate with the percentage of wages offered for each slot or time interval, providing agents with valuable insights to make informed decisions regarding accepting overtime or taking time off. By making the benefits transparent, agents can choose shifts strategically, and managers can motivate agents to fill urgent business requirements by offering attractive incentives.

Advantageously, by providing agents with clear and up-to-date information about their earnings when they work extra hours (or take time off) in the WFM system, agents are empowered to make informed decisions and their motivation to take on additional shifts when needed is increased. This transparency is essential for building trust and maintaining a positive work environment, and facilitates both employee-agents and managers to make faster and better decisions using increased information according to the present disclosure.

Customers also benefit by having a seamless experience, even in case of emergency business needs. The present invention drives everyone using a WFM system towards a win-win situation by keeping agents, managers, and customers satisfied and happy. Not only does this improve customer satisfaction (CSAT) scores and net promoter scores (NPS), but it also provides maximum flexibility to agents and reduces costs by helping managers make more informed decisions.

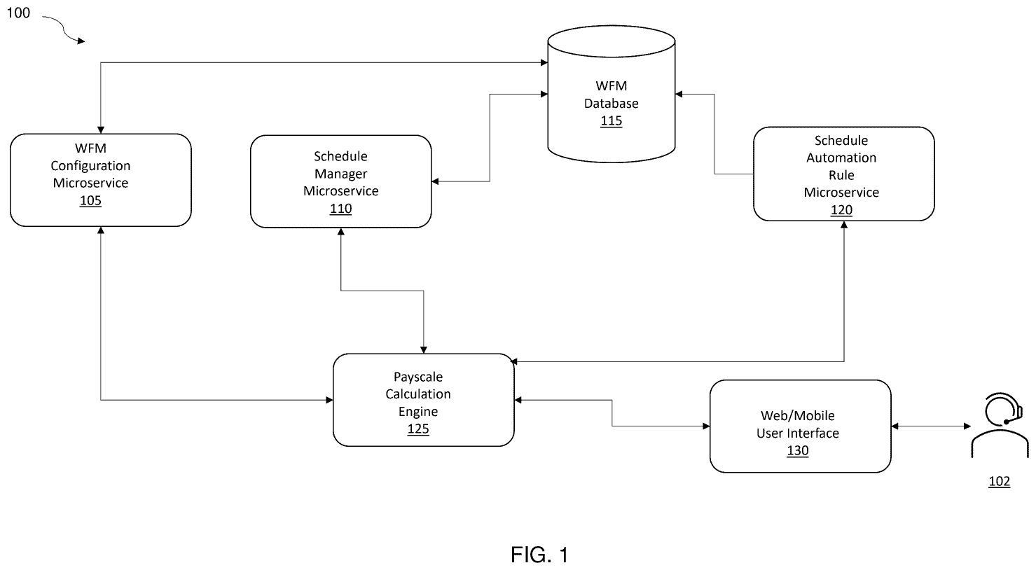

FIG. 1 illustrates an earnings visibility system 100 according to embodiments of the present disclosure. As shown, the earnings visibility system 100 includes WFM configuration microservice 105, schedule manager microservice 110, WFM database 115, schedule automation rule microservice 120, payscale calculation engine 125, and web/mobile user interface 130.

WFM configuration microservice 105 is a Java-based spring boot microservice designed to operate within the Amazon Web Services (AWS) cloud environment, utilizing Elastic Container Service (ECS) for deployment. Leveraging multi-availability zones enhances the service's resilience by ensuring redundancy across different physical locations. The primary objective of this microservice is to facilitate configuration management for WFM functionalities. Through a set of representational state transfer application program interfaces (REST APIs), users can interact with the service to store and retrieve various configuration entities crucial for WFM operations. One significant aspect of this service is its role in supporting innovation activities. Specifically, it serves as a central repository for activity code and associated payroll code configurations. Other parts of the system 100 can access this data via REST APIs to streamline processes and ensure consistency. Administrators and managers are empowered to manage activity code and payroll code configurations effectively using the REST endpoints provided by the configuration service. This enables seamless administration and customization of configurations tailored to the organization's needs.

Schedule manager microservice 110 is a Java-based spring boot microservice that operates within the AWS (or other) cloud infrastructure, leveraging ECS for containerized deployment. By distributing its containers across multiple availability zones, the service ensures resilience against failures by maintaining redundant instances across distinct physical locations.

Its core functionality revolves around generating staffing summaries based on historical forecasted requirements, which serves as the basis for scheduling agents' work shifts. This involves an asynchronous process driven by user inputs, where staffing data is computed in response to forecasted demands using AWS batch service.

The microservice reveals a comprehensive set of REST APIs, enabling users to retrieve detailed information about net staffing summaries per specified intervals. These APIs support various filters such as WFM skills, agents, and scheduling units, allowing for precise querying and analysis.

Innovatively, the service interfaces with a payscale calculation engine 125 as part of the solution architecture. For each interval, payscale calculation engine 125 dynamically fetches staffing requirements from schedule manager microservice 110, applying predefined rules to calculate wages based on an agent's selected time slots. This integration optimizes WFM by aligning compensation with staffing needs in real-time.

Similar to schedule manager microservice 110, schedule automation rule microservice 120 is a Java-based spring boot microservice that operates within the AWS (or other) cloud infrastructure, harnessing the power of ECS for streamlined containerized deployment. Through intelligent distribution across multiple availability zones, the service ensures robust resilience against potential failures, safeguarding continuity by maintaining redundant instances across diverse physical locations.

At its core, the microservice facilitates the dynamic creation of time off and extra hours rules by managers and administrators. These rules are meticulously tailored to match staffing requirements per activity code, offering a spectrum of actions including auto-approval, manager approval, and declined responses, thereby streamlining WFM processes.

The automation rules feature extends to encompass configurations of pay scales, allowing for dynamic adjustments based on staffing requirements. This functionality empowers organizations to optimize compensation strategies in real-time, aligning wages with workforce needs dynamically.

The microservice exposes a rich array of REST APIs, empowering users to seamlessly access and manipulate time off and extra hours rules. Leveraging this functionality, the schedule manager microservice 110 provides valuable insights into wages per interval, enabling agents to make informed decisions regarding slot applications that align with their requirements and preferences.

Payscale calculation engine 125 depends on input data received from different WFM microservices, which are deployed as AWS ECS containers and using AWS Relational Database Service (RDS) as data storage (e.g., WFM database 115). Payscale calculation engine 125 receives a net staffing summary from schedule manager microservice 110 and payroll rules per activity code from schedule automation rule microservice 120. These two pieces of information are processed in payscale calculation engine 125. Schedules with the payroll insights are then painted on the web/mobile user interface 130 of the agent 102.

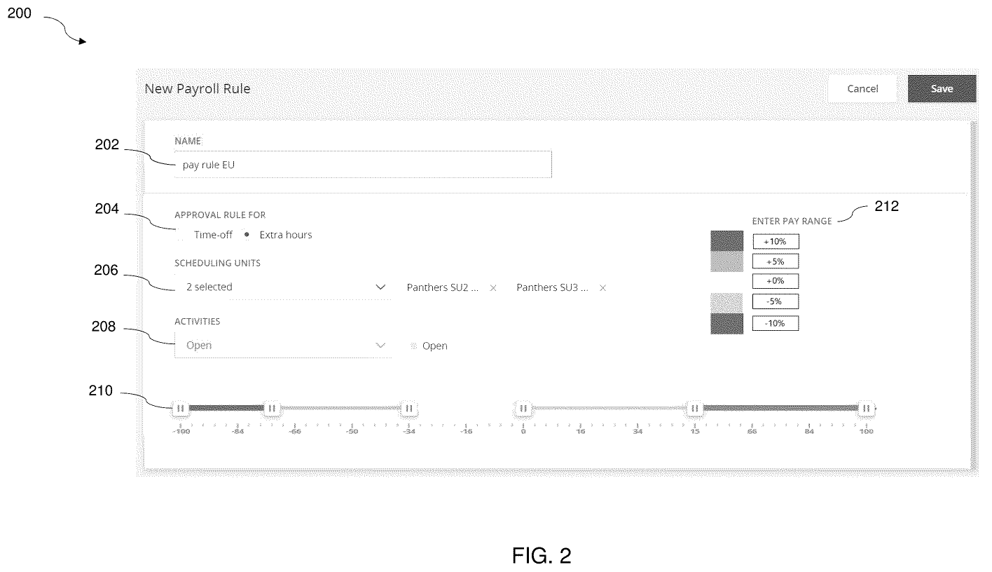

Referring now to FIG. 2, in one or more embodiments, the present systems and methods allow managers to create payroll rules that define agents' wages and the variance of the wages for the agents. In an exemplary embodiment, a manager first creates a new payroll rule including a unique name 202 for the rule. Next, the manager determines if the payroll rule is for time off or extra hours at section 204. The manager then selects the scheduling unit 206 and the activities 208 that the payroll rule is for. With the scale 210 provided, the manager can define the percentage for the wages or pay range 212 that will be provided to the agents. For example, say 5% above the base salary or 5% less than the base salary for an extra hours' slot. The manager can define the scale for that scheduling unit with these payroll rules. The defined color codes are followed to paint the interval level slots on the agent's screen.

FIG. 2 is an exemplary payroll rule creation page 200, which can be updated by a manager. As can be seen, when the manager creates a new payroll rule, the manager decides on a name 202 for the payroll rule and if this particular rule is for time off or extra hours at section 204. In the illustrated example, the manager chose extra hours. The respective scheduling units 206 and the corresponding activity codes 208 are selected that would be allowed for extra hours. The pay range 212 is seen as per the color gradients and defined by the manager on the scale 210. If the manager wants to pay 5% above the base salary for a particular extra hour slot or time interval, in one embodiment, it would be painted in light green color on the agent user interface.

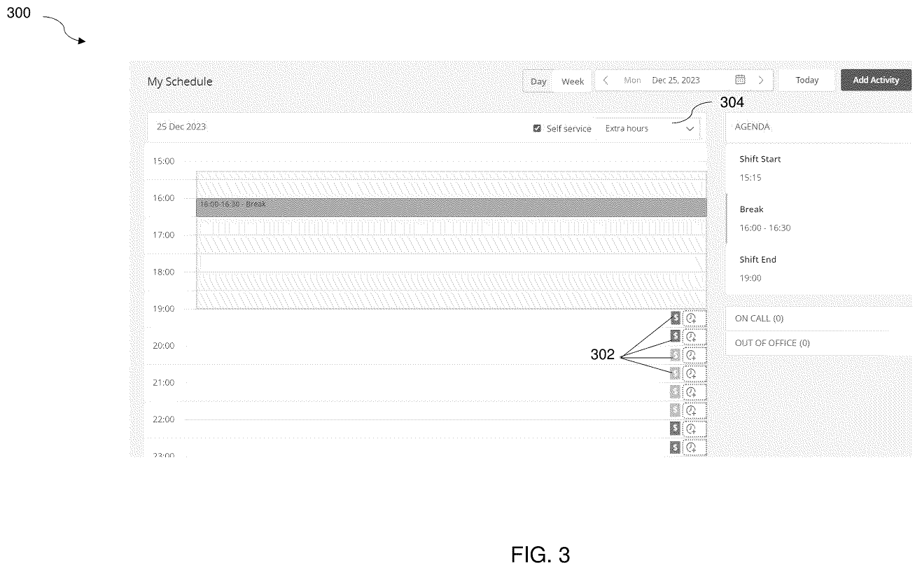

FIG. 3 illustrates a user interface 300 for an agent 102 according to the present disclosure. The user interface 300 provides earning insights by using different colors on time intervals 302. Certain time intervals 302 can be dark green, while other time intervals 302 can be light green. The earnings insights (via the different colors) are provided to agents before they apply for extra hours 304 or ask for time off.

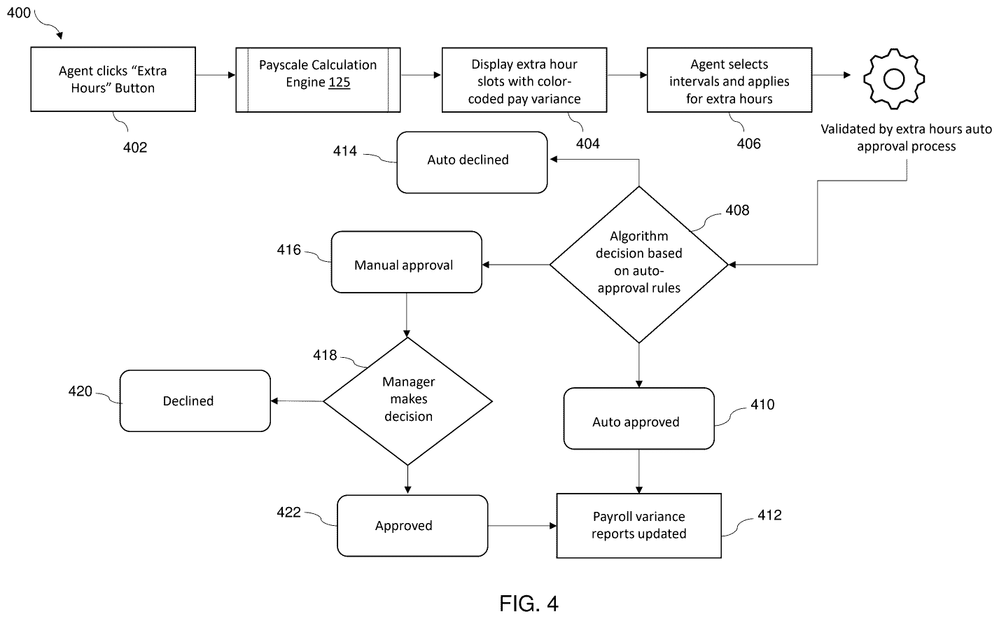

FIG. 4 shows an exemplary method 400 for requesting extra hours according to the present disclosure. Once agent 102 decides to request extra hours, he/she can click the “extra hours” button 304 on the user interface 300 in step 402. On the backend, the payscale calculation engine 125 retrieves the payroll rule that is set by the manager, processes the rule conditions, net staffing, and the algorithms to paint the extra hours' slots according to payroll variance, and colors the extra hour time slots in step 404. In one embodiment, different colors can be used to signify the effect of a shift request change on earnings, e.g., light green for up to a certain level of increased compensation, dark green for more, and light red and dark red for increasing amounts of lost compensation. In step 406, agent 102 can decide to choose the slot(s) based on the color(s) and his/her preferences, and apply for the extra hours.

In the embodiment of FIG. 4, there is automatic approval of extra hours in the WFM system, which evaluates the request for extra hours according to the extra hours rule. WFM system sends the request through the algorithm in step 408 where it is automatically approved, or where it is “pre-approved” for a manager's final approval, in step 410, automatically declined in step 414, or sent for manual approval in step 416. The manager typically then makes a decision in step 418, either declining the request in step 420 or approving the request in step 422. If the request is automatically approved or pre-approved and then approved by the manager in step 410 or manually approved by the manager in step 422, the payroll variance data for that time interval is updated in a separate report called the payroll variance report.

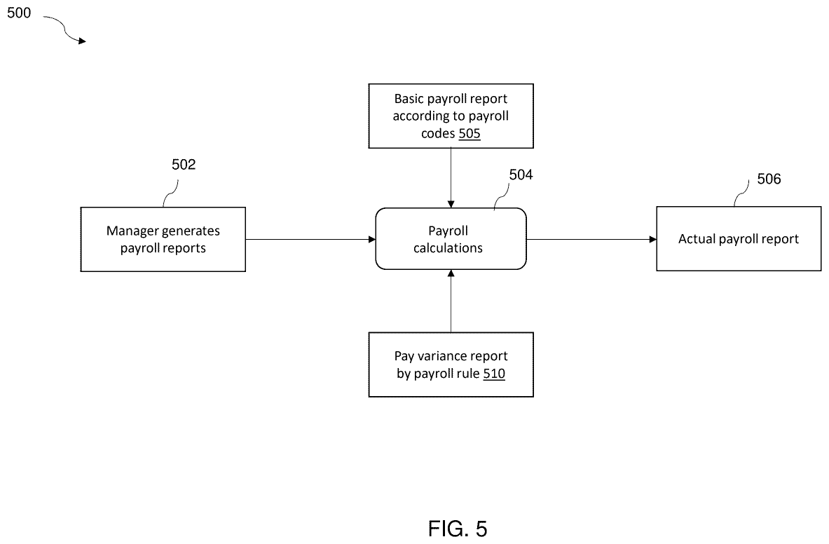

FIG. 5 shows a method 500 for generating a payroll report according to embodiments of the present disclosure. At step 502, whenever a manager needs a payroll report, the system 100 can calculate the actual payroll data based on the basic payroll codes 505 and a newly generated payroll variance report 510. After the payroll calculations at step 504, the actual payroll report is generated at step 506.

In general, there are payroll codes in WFM systems. Each activity performed by an agent has a specific payroll code mapped to it, which contains the payroll information for that activity. Payroll codes are configured by managers in WFM systems. For example, for a particular activity such as “overtime,” the earnings that an agent will receive will be “X” amount. Depending on the staffing situation, the value for “X” will vary. In various embodiments, the manager defines the value of “X” on a configuration page. The actual values for the payroll codes are defined by the organizations and are received from the payroll systems.

To generate the payroll report calculations, the inputs (e.g., for each 15 minutes) are net staffing percentage (n %), pay scale from the payroll code ($ per minute), and pay variance (from payroll rule based on net staffing).

As an example, assume the following:

TABLE 1
PAYROLL RULE

| Staffing Range | Pay Variance (%) |
|---|---|
| >120 | −10 |
| 100-120 | −5 |
| 80-100 | +5 |
| <80 | +10 |

TABLE 2
PAYSCALE FROM PAYROLL CODE

| Skill | Pay Per Minute ($) |
|---|---|
| Speak English | 10 |
| Speak Mandarin | 5 |

TABLE 3
ACTUAL PAY PER MINUTE FORMULA

Actual Pay (P) = p ± (p*v/100)

Assume that the required agents for the time interval starting at 7:45 AM are 55. These are the number of agents required at that interval according to the forecasted call volume. The scheduled agents are 50. These are the number of agents for whom schedules are generated and they are bound to work in this interval. To calculate net staffing, the formula below is used:

$$( Scheduled Agents - Required Agents ) / ( Scheduled Agents ) \to ( 50 - 55 ) / 50 = - 10 \%$$

The staffing range according to the payroll rule (Table 1) at net staffing of −10%, which corresponds to 90% staffing, is less than 100% and more than 80% staffing. Therefore, the pay variance is +5%. Actual pay per minute=10+(10*5/100)=$10.5 per minute.

Therefore, the agent gets an extra $0.50 per minute for working in the understaffed situation, which attracts more agents to work in such kinds of situations where the contact center needs more agents to work.

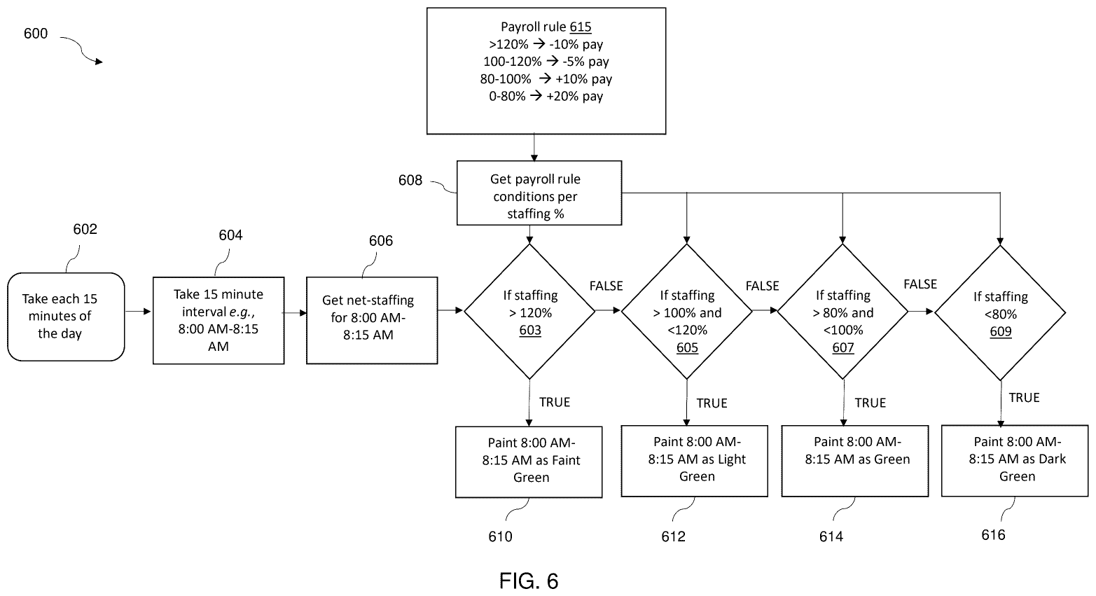

FIG. 6 shows an exemplary algorithm 600 according to embodiments of the present disclosure. At step 602, the day is broken up into 15-minute intervals. At step 604, a specific time interval (e.g., 8 AM-8:15 AM) is taken. At step 606, the net staffing for that specific time interval is obtained. At step 608, the payroll rule 615 defined by the manager for that specific time interval is obtained. In FIG. 6, the payroll rule 615 sets out the variance (percentage increase or percentage decrease) in pay for different staffing conditions.

The staffing situation 603, 605, 607, and 609 is then compared with the variance groups in the payroll rule. The color of the specific time interval depends on where the staffing situation falls.

If the staffing range is greater than 120%, there are more agents than needed, and the time interval is painted faint green at step 610. If the staffing range is greater than 100% and less than 120%, there are still more agents than needed, and the time interval is painted light green. If the staffing range is greater than 80% and less than 100%, more agents are needed, and the time interval is painted green. If the staffing range is less than 80%, there is an urgent need for more agents, and the time interval is painted dark green.

In this specific embodiment of FIG. 6, the darker color means higher pay. Colors can be defined by the managers, assigned by default, or provided by the system 100.

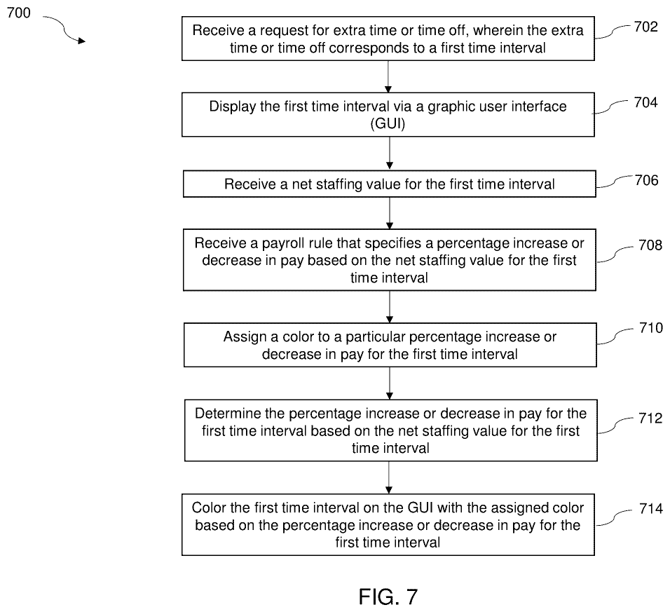

Referring now to FIG. 7, shown is an exemplary method 700 according to the present disclosure. At step 702, payscale calculation engine 125 receives, from agent 102, a request for extra time or time off, wherein the extra time or time off corresponds to a first time interval. For example, agent 102 may request extra time for the time interval 7:15 AM-7:30 AM.

At step 704, web/mobile user interface 130 displays the first time interval via a graphical user interface (e.g. graphical user interface 300).

At step 706, payscale calculation engine 125 receives a net staffing value for the first time interval from schedule manager microservice 110. Net staffing describes the staffing situation at each time interval (e.g., every 15 minutes), and tells the manager if these intervals are understaffed or overstaffed according to requirements given by the forecast. In some embodiments, payscale calculation engine 125 calculates the net staffing value for the first time interval.

At step 708, payscale calculation engine 125 receives, from a manager via schedule automation rule microservice 120, a payroll rule that specifies a percentage increase or decrease in pay based on the net staffing value for the first time interval. In various embodiments, the payroll rule has a configuration to calculate pay variance according to a change in net staffing. Payroll rules are generally associated with specific activities and scheduling units, and can be applied to requests for time off and requests for extra hours.

At step 710, payscale calculation engine 125 assigns a color to a particular percentage increase or decrease in pay for the first time interval. In one embodiment, the color is part of a gradient that goes from a dark color or a light color (or vice versa). In other embodiments, the colors are not part of a gradient.

At step 712, payscale calculation engine 125 determines the percentage increase or decrease in pay for the first time interval based on the net staffing value for the first time interval. In several embodiments, the percentage increase in pay in greater for an interval where the net staffing value has a high negative percentage (e.g., −25%).

At step 714, payscale calculation engine 125 colors or paints the first time interval on the GUI with the assigned color based on the percentage increase or decrease in pay for the first time interval.

In one or more embodiments, method 700 also includes receiving a net staffing value for a second time interval; receiving, from a manager, a payroll rule that specifies a percentage increase or decrease in pay based on the net staffing value for the second time interval; assigning a color to a particular percentage increase or decrease in pay for the second time interval; determining the percentage increase or decrease in pay for the second time interval based on the net staffing value for the second time interval; coloring the second time interval on the GUI with the assigned color based on the percentage increase or decrease in pay for the second time interval; and displaying the color for the first time interval and the color for the second time interval on the GUI. In other words, more than one time interval is colored. In one or more embodiments, a plurality of time intervals are colored (e.g., FIG. 3).

In certain embodiments, the method 700 also includes calculating earnings of the agent for the first time interval, and displaying the calculated earnings on the GUI. In some embodiments, the method 700 also includes providing an earnings report of the agent, an earnings history of the agent, or both on the GUI.

In several embodiments, the method 700 also includes receiving, from the agent, a selection of the first time interval via the GUI, notifying the manager of the selection, and receiving automatic approval or manual approval from the manager of the request for extra time or time off. Managers in WFM can configure a rule to auto-approve or auto-decline the extra hours or time off requests by the agent based on the staffing situation, seniority, submission in advance and likewise parameters.

In one embodiment, the payroll rule is maintained for the first time interval in a payroll variance report when there is automatic or manual approval. In various embodiments, a payroll report is generated for the agent by calculating actual pay for the agent based on the payroll code and the payroll variance report.

Shown below is an example of payroll code and activity code association data:

```
{
  “payrollCodeMappings” : [ {
    “id” : “11eec4ca-2e23-7e60-a61b-0242ac110003”,
    “activityCodeId” : “11edda07-c0df-4f80-8528-0242ac110006”,
    “payrollCodeId” : “11eec4ca-2e21-d0b0-a61b-0242ac110003”,
    “createdTime” : “2024-02-06T08:31:53Z”,
    “createdBy” : “11edc494-cc67-76d0-a708-0242ac110003”,
    “validFrom” : “2024-02-06T08:31:53Z”,
    “validTo” : null,
    “currentFlag” : true,
    “deleteFlag” : false
  } ]
}
      Below are net staffing data for a WFM skill:
{
  “totalNet” : [ {
    “periodStartTime” : “2024-01-29T03:00:00Z”,
    “required” : null,
    “staffed” : 0.0,
    “net” : 0.0
  }, {
    “periodStartTime” : “2024-01-29T03:15:00Z”,
    “required” : null,
    “staffed” : 0.0,
    “net” : 0.0
  }
```

Below are automatic approval rules data:

```
“timeOffRules” : [ {
  “ruleId” : “11ee3f23-9607-e890-a59f-0242ac110006”,
  “ruleName” : “TimeOff”,
  “allotmentType” : “fixed”,
  “allottedDays” : 10.0,
  “seniorityBasedAllotmentConfiguration” : null,
  “schedulingUnitId” : “11e8db49-f43e-76b0-b954-0242ac110002”,
  “schedulingUnitName” : “perm_pm_kepler”,
  “activityCodeId” : “b0fc3028-9754-1100-0000-000000000000”,
  “activityCodeName” : “Paid Time Off”,
  “accrualType” : null,
  “accrualValue” : null,
  “allowCarryOver” : false,
  “carryOverDays” : null
}
```

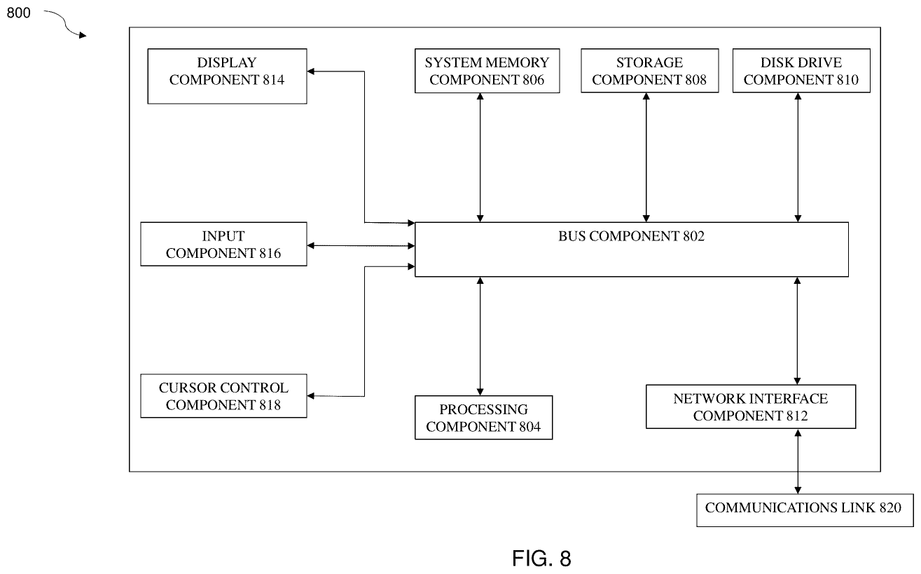

Referring now to FIG. 8, illustrated is a block diagram of a system 800 suitable for implementing embodiments of the present disclosure. System 800, such as part of a computer and/or a network server, includes a bus 802 or other communication mechanism for communicating information, which interconnects subsystems and components, including one or more of a processing component 804 (e.g., processor, micro-controller, digital signal processor (DSP), etc.), a system memory component 806 (e.g., RAM), a static storage component 808 (e.g., ROM), a network interface component 812, a display component 814 (or alternatively, an interface to an external display), an input component 816 (e.g., keypad or keyboard), and a cursor control component 818 (e.g., a mouse pad).

In accordance with embodiments of the present disclosure, system 800 performs specific operations by processor 804 executing one or more sequences of one or more instructions contained in system memory component 806. Such instructions may be read into system memory component 806 from another computer readable medium, such as static storage component 808. These may include instructions to receive, from an agent, a request for extra time or time off, wherein the extra time or time off corresponds to a first time interval; display the first time interval via a graphical user interface (GUI); receive a net staffing value for the first time interval; receive, from a manager, a payroll rule that specifies a percentage increase or decrease in pay based on the net staffing value for the first time interval; assign a color to a particular percentage increase or decrease in pay for the first time interval; determine the percentage increase or decrease in pay for the first time interval based on the net staffing value for the first time interval; and color the first time interval on the GUI with the assigned color based on the percentage increase or decrease in pay for the first time interval. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 804 for execution. Such a medium may take many forms, including but not limited to, non-volatile media, volatile media, and transmission media. In various implementations, volatile media includes dynamic memory, such as system memory component 806, and transmission media includes coaxial cables, copper wire, and fiber optics, including wires that comprise bus 802. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 800. In various other embodiments, a plurality of systems 800 coupled by communication link 820 (e.g., LAN, WLAN, PTSN, or various other wired or wireless networks) may perform instruction sequences to practice the disclosure in coordination with one another. Computer system 800 may transmit and receive messages, data, information and instructions, including one or more programs (i.e., application code) through communication link 820 and communication interface 812. Received program code may be executed by processor 804 as received and/or stored in disk drive component 810 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. An earnings visibility system comprising:
a processor and a non-transitory computer readable medium operably coupled thereto, the non-transitory computer readable medium comprising a plurality of instructions stored in association therewith that are accessible to, and executable by, the processor, to perform operations which comprise:
receiving, from an agent, a request for extra time or time off, wherein the extra time or time off corresponds to a first time interval;
displaying the first time interval via a graphical user interface (GUI);
receiving a net staffing value for the first time interval;
receiving, from a manager, a payroll rule that specifies a percentage increase or decrease in pay based on the net staffing value for the first time interval;
assigning a color to a particular percentage increase or decrease in pay for the first time interval;
determining the percentage increase or decrease in pay for the first time interval based on the net staffing value for the first time interval; and
coloring the first time interval on the GUI with the assigned color based on the percentage increase or decrease in pay for the first time interval.

2. The earnings visibility system of claim 1, wherein the operations further comprise calculating the net staffing value for the first time interval.

3. The earnings visibility system of claim 1, wherein the operations further comprise:
receiving a net staffing value for a second time interval;
receiving, from a manager, a payroll rule that specifies a percentage increase or decrease in pay based on the net staffing value for the second time interval;
assigning a color to a particular percentage increase or decrease in pay for the second time interval;
determining the percentage increase or decrease in pay for the second time interval based on the net staffing value for the second time interval;
coloring the second time interval on the GUI with the assigned color based on the percentage increase or decrease in pay for the second time interval; and
displaying the color for the first time interval and the color for the second time interval on the GUI.

4. The earnings visibility system of claim 1, wherein the operations further comprise:
calculating earnings of the agent for the first time interval; and
displaying the calculated earnings on the GUI.

5. The earnings visibility system of claim 1, wherein the operations further comprise:
receiving, from the agent, a selection of the first time interval via the GUI;
notifying the manager of the selection; and
receiving automatic approval or manual approval from the manager of the request for extra time or time off.

6. The earnings visibility system of claim 5, wherein the operations further comprise maintaining the payroll rule for the first time interval in a payroll variance report.

7. The earnings visibility system of claim 6, wherein the operations further comprise generating a payroll report for the agent by calculating actual pay for the agent based on a payroll code and the payroll variance report.

8. The earnings visibility system of claim 1, wherein the operations further comprise providing an earnings report of the agent, an earnings history of the agent, or both on the GUI.

9. A method for facilitating earnings visibility, which comprises:
receiving, from an agent, a request for extra time or time off, wherein the extra time or time off corresponds to a first time interval;
displaying the first time interval via a graphical user interface (GUI);
receiving a net staffing value for the first time interval;
receiving, from a manager, a payroll rule that specifies a percentage increase or decrease in pay based on the net staffing value for the first time interval;
assigning a color to a particular percentage increase or decrease in pay for the first time interval;
determining the percentage increase or decrease in pay for the first time interval based on the net staffing value for the first time interval; and
coloring the first time interval on the GUI with the assigned color based on the percentage increase or decrease in pay for the first time interval.

10. The method of claim 9, which further comprises:
receiving a net staffing value for a second time interval;
receiving, from a manager, a payroll rule that specifies a percentage increase or decrease in pay based on the net staffing value for the second time interval;
assigning a color to a particular percentage increase or decrease in pay for the second time interval;
determining the percentage increase or decrease in pay for the second time interval based on the net staffing value for the second time interval;
coloring the second time interval on the GUI with the assigned color based on the percentage increase or decrease in pay for the second time interval; and
displaying the color for the first time interval and the color for the second time interval on the GUI.

11. The method of claim 9, which further comprises:
calculating earnings of the agent for the first time interval; and
displaying the calculated earnings on the GUI.

12. The method of claim 9, which further comprises:
receiving, from the agent, a selection of the first time interval via the GUI;
notifying the manager of the selection; and
receiving automatic approval or manual approval from the manager of the request for extra time or time off.

13. The method of claim 12, which further comprises maintaining the payroll rule for the first time interval in a payroll variance report.

14. The method of claim 13, which further comprises generating a payroll report for the agent by calculating actual pay for the agent based on a payroll code and the payroll variance report.

15. The method of claim 9, which further comprises providing an earnings report of the agent, an earnings history of the agent, or both on the GUI.

16. A non-transitory computer-readable medium having stored thereon computer-readable instructions executable by a processor to perform operations which comprise:
receiving, from an agent, a request for extra time or time off, wherein the extra time or time off corresponds to a first time interval;
displaying the first time interval via a graphical user interface (GUI);
receiving a net staffing value for the first time interval;
receiving, from a manager, a payroll rule that specifies a percentage increase or decrease in pay based on the net staffing value for the first time interval;
assigning a color to a particular percentage increase or decrease in pay for the first time interval;
determining the percentage increase or decrease in pay for the first time interval based on the net staffing value for the first time interval; and
coloring the first time interval on the GUI with the assigned color based on the percentage increase or decrease in pay for the first time interval.

17. The non-transitory computer-readable medium of claim 16, wherein the operations further comprise:
receiving a net staffing value for a second time interval;
receiving, from a manager, a payroll rule that specifies a percentage increase or decrease in pay based on the net staffing value for the second time interval;
assigning a color to a particular percentage increase or decrease in pay for the second time interval;
determining the percentage increase or decrease in pay for the second time interval based on the net staffing value for the second time interval;
coloring the second time interval on the GUI with the assigned color based on the percentage increase or decrease in pay for the second time interval; and
displaying the color for the first time interval and the color for the second time interval on the GUI.

18. The non-transitory computer-readable medium of claim 16, wherein the operations further comprise:
receiving, from the agent, a selection of the first time interval via the GUI;
notifying the manager of the selection; and
receiving automatic approval or manual approval from the manager of the request for extra time or time off.

19. The non-transitory computer-readable medium of claim 18, wherein the operations further comprise maintaining the payroll rule for the first time interval in a payroll variance report.

20. The non-transitory computer-readable medium of claim 19, wherein the operations further comprise generating a payroll report for the agent by calculating actual pay for the agent based on a payroll code and the payroll variance report.
